(19) United States
(12) Patent Application Publication
(10) Pub. No.: US 2006/0193371 A1
(43) Pub. Date: Aug. 31, 2006

(54) Synchronization And Channel Estimation With Sub-Nyquist Sampling In Ultra-Wideband Communication Systems

(76) Inventor: Irena Maravic, West Kensington, London (GB)

Correspondence Address: Peter A Businger, 373 Park Avenue, Suite 205, Scotch Plains, NJ, 07076-1145, US

(21) Appl. No.: 10/550,141

(22) PCT Filed: Mar. 22, 2004
(86) PCT No.: PCT/US04/08871

§ 371 Date: Mar. 13, 2006

Related U.S. Application Data
(60) Provisional application No. 60/456,397, filed on Mar. 21, 2003.

(51) Int. Cl. H04B 1/69

(52) U.S. Cl. 375/130

(57) ABSTRACT

The system and method for estimating impulse response of a wideband communication channel represented as linear combination of L time-shifted pulsed P₁(t) with propagation coefficients a1, comprising functionalities or steps for obtaining an ultrawideband signal (y(t) of FIG. 1) received over the channel, filtered (h₍₁₎ of FIG. 1) with low pass/bandpass filter and sampled uniformly at a sub-Nyquist rate; a functionality for determining discrete-Fourier-transform coefficients Yⱼ and Sⱼ (FFT of FIG. 1) from the sampled received signal and a transmitted ultra-wide-band pulse, respectively; a functionality for determining dominant singular vectors of a matrix having Yⱼ₊ₗ₄ /S_{j+i4,} as its i, j-elements; a functionality for estimating a plurality of powers of signal poles from the dominant singular vectors and determining the times shifts from the estimated powers; and a functionality for determining the propagation coefficients from a system of linear equalizations.

### FIELD OF THE INVENTION

The invention is concerned with ultra-wideband communication systems and, more particularly, with synchronization and channel estimation in such systems.

### BACKGROUND OF THE INVENTION

Ultra-wideband (UWB) technology has received considerable recent attention for benefits of extremely wide transmission bandwidth, such as very fine time resolution for accurate ranging and positioning, as well as multi-path fading mitigation in indoor wireless networks. UWB systems use trains of pulses of very short duration, typically on the order of a nanosecond, thus spreading the signal energy from near DC to a few gigahertz. While techniques for UWB signaling have been investigated for a considerable time, primarily for radar and remote-sensing applications, the technology remains to be developed further. There is particular interest in low-power and low-cost designs, and in efficient digital techniques.

The properties that make UWB a promising candidate for a variety of new applications also make for challenges to analysis and practice of reliable systems. One design challenge lies with rapid synchronization, as synchronization accuracy and complexity directly affect system performance. In this respect there is a considerable amount of recent literature, with a common trend to minimize the number of analog components needed, and perform as much as possible of the processing digitally. Yet, given the wide bandwidths involved, digital implementation may lead to prohibitively high costs in terms of power consumption and receiver complexity. For example, conventional techniques based on sliding correlators would require very fast and expensive A/D converters, operating with high power consumption in the gigahertz range. Implementation of such techniques in digital systems would have near-prohibitive complexity as well as slow convergence because of the exhaustive search required over thousands of fine bins, each at the nanosecond level.

For improving the acquisition speed, several modified timing recovery schemes have been proposed, such as a bit reversal search, or the correlator-type approach exploiting properties of beacon sequences. Even though some of these techniques have been in use in certain analog systems, their need for very high sampling rates, along with their search-based characteristics, makes them less attractive for digital implementation. Recently, a family of blind synchronization techniques was developed, which takes advantage of the so-called cyclo-stationarity of UWB signaling, i.e. the fact that every information symbol is made up of UWB pulses that are periodically transmitted, one per frame, over multiple frames. While such an approach relies on frame-rate rather than Nyquist rate sampling, it still requires large data sets to achieve good synchronization performance.

Another challenge arises from the fact that the design of an optimal UWB receiver must take into account certain frequency-dependent effects on the received waveform. Due to the broadband nature of UWB signals, the components propagating along different paths typically undergo different frequency-selective distortions. As a result, a received signal is made up of pulses with different pulse shapes, which makes optimal receiver design a considerably more delicate task than in other wideband systems. In previous techniques, an array of sensors is used to spatially separate the multi-path components, which then is followed by identification of each path using an adaptive method, the so-called Sensor-CLEAN algorithm. Due to the complexity of the method and the need for an antenna array, the method has been used mainly for UWB propagation experiments. There remains a desire for simpler and faster algorithms for handling realistic channels which can be used in low-complexity UWB transceivers.

### SUMMARY OF THE INVENTION

We have devised a technique for channel estimation and timing in digital UWB receivers which allows for sub-Nyquist sampling rates and reduced receiver complexity, while retaining performance. The technique is predicated on sampling of certain classes of parametric non-bandlimited signals that have a finite number of degrees of freedom per unit of time, or finite rate of innovation. The minimum required sampling rate in UWB systems is determined by the innovation rate of the received UWB signal, rather than the Nyquist rate or the frame rate. A frequency-domain technique can yield high-resolution estimates of channel parameters by sampling a low-dimensional subspace of the received signal. The technique allows for considerably lower sampling rates, and for reduced complexity and power consumption as compared with prior digital techniques. It is particularly suitable in applications such as precise position location or ranging, as well as for synchronization in wideband systems. The technique can also be used for characterization of general wideband channels, without requiring additional hardware support.

### BRIEF DESCRIPTION OF THE DRAWINGS

FIG. 1 is a block diagram of a receiver implementing an exemplary embodiment of the technique.

FIG. 2 is a block diagram of a receiver implementing an exemplary alternative embodiment of the technique, with estimation from multiple bands.

FIG. 3a is a graph of a transmitted UWB pulse, channel impulse response, and received multi-path signal.

FIG. 3b is a graph of a transmitted sequence of UWB pulses and a received signal.

FIG. 4 is a graph of root-mean-square error (RMSE) of delay estimation versus signal-to-noise ratio (SNR) for one dominant path.

FIG. 5 is a graph of RMSE of delay estimation of two dominant components versus relative time delay between pulses.

FIG. 6 is a graph of RMSE versus SNR for two-step delay estimation.

FIG. 7a is a graph of signal versus time in a higher-rank model.

FIG. 7b is a graph of RMSE of delay estimation of dominant components versus SNR

FIG. 7c is a graph of RMSE versus SNR for different quantizations of a signal.

### DETAILED DESCRIPTION

A. Channel Estimation at Low Sampling Rate

Propagation studies for ultra-wideband signals have taken into account temporal properties of a channel, or have characterized a spatio-temporal channel response. A typical model for the impulse response of a multi-path fading channel can be represented by

$$h ( t ) = {\sum }_{l = 1}^{L} {a}_{l} δ ( t - {t}_{l} ) \qquad ( 1 )$$

where tₗ denotes a signal delay along the l-th path and aₗ is a complex propagation coefficient which includes a channel attenuation and a phase offset along the l-th path. Although this model does not adequately reflect specific bandwidth-dependent effects, it is commonly used for diversity reception schemes in conventional wideband receivers, e.g. so-called RAKE receivers. Equation (1) can be interpreted as saying that a received signal y(t) is made up of a weighted sum of attenuated and delayed replicas of a transmitted signal s(t), i.e.

$$y ( t ) = {\sum }_{l = 1}^{L} {a}_{l} s ( t - {t}_{l} ) + η ( t ) \qquad ( 2 )$$

where η(t) denotes receiver noise. The received signal y(t) has only 2 L degrees of freedom, represented by time delays tₗ and propagation coefficients aₗ. When s(t) is known a priori and there is no noise, the signal can be reconstructed by taking just 2 L samples of y(t), which fact underlies a new sampling technique for signals of finite innovation rate. In particular, the minimum required sampling rate typically is determined by the number of degrees of freedom per unit of time, i.e. the innovation rate. While the unknown parameters can be estimated using the time domain model represented by Equation (2), an efficient, closed-form solution can be provided in the frequency domain.

In the following, Y(ω) denotes the Fourier transform of the received signal,

$$Y ( ω ) = {\sum }_{l = 1}^{L} {a}_{l} S ( ω ) {ⅇ}^{- jω {t}_{\cdot l}} + 𝒩 ( ω ) \qquad ( 3 )$$

where S(ω) and N(ω) are the Fourier transforms of s(t) and η(t), respectively. Thus, spectral components are determined as a sum of complex exponentials, where the unknown time delays appear as complex frequencies, and the propagation coefficients as unknown weights. With the frequency domain representation of the signal, the problem of estimating the unknown channel parameters tₗ and aₗ has been converted into a harmonic retrieval problem.

For high-resolution harmonic retrieval there exists a rich body of literature on both theoretical limits and efficient algorithms for reliable estimation. A particularly attractive class of model-based algorithms, called super-resolution methods, can resolve closely spaced sinusoids from a short record of noise-corrupted data. A polynomial realization has been discussed, where the parameters are estimated from zeros of the so-called prediction or annihilating filter. And a state-space method has been proposed to estimate parameters of superimposed complex exponentials in noise, providing an appealing, numerically robust tool for parameter estimation using a subspace-based approach. The so-called ESPRIT algorithm can be viewed as a generalization of the state space method applicable to general antenna arrays. There are several subspace techniques for estimating generalized eigenvalues of matrix pencils, such as the Direct Matrix Pencil algorithm, Pro-ESPRIT, and its improved version TLS-ESPRIT.

Another class of algorithms is based on the optimal maximum likelihood (ML) estimator; however, ML methods generally require L-dimensional search and are computationally more demanding than the subspace-based algorithms. In most cases encountered in practice, subspace methods can achieve performances close to those of the ML estimator, and are thus considered to be a viable alternative, provided a low-rank system model is available.

The following is predicated on a model-based approach, to show that it is possible to obtain high-resolution estimates of all the relevant parameters by sampling the received signal below the traditional Nyquist rate. FIG. 1 shows a corresponding general structure. A polynomial realization of the estimator is described first, illustrating fundamental principles for high-resolution estimation from a sub-sampled version of a received signal.

B. Polynomial Realization of Model-Based Techniques

A received signal y(t) can be filtered with an ideal bandpass filter H_{b}=rect(ω_{L}, ω_{U}) of bandwidth B=ω_{U}-ω_{L} under the simplifying assumption that ω_{L}=kB, where k is a non-negative integer number. From the filtered version, a uniform set of samples can be taken, {yₙ, n from 0 to N−1}:
yₙ=<h_{b}(t−nT),y(t)>,n+0, . . . , N−1 (4)
where T is the sampling period and h_{b}(t) is the time domain representation of the filter H_{b}. The above assumption on the position of the filter passband allows for sampling the signal at a rate determined by the bandwidth of the filter, Rₛ≧2·B/2π, which is commonly referred to as bandpass sampling. An alternative, more conventional technique involves down-converting the filtered version prior to sampling, which also allows for sub-Nyquist sampling rates, but requires additional hardware stages in the analog front end. From the set of samples {yₙ, n from 0 to N−1}, one can compute N uniformly spaced samples of the Fourier transform Y(ω),

$$Y [ n ] = Y ( {ω}_{L} + {n ω}_{0} ) , where {ω}_{0} = \frac{B}{N - 1} , n = 0 , … N - 1. \qquad ( 5 )$$

With the notation Yₛ[n]=Y[n]/S[n], where S[n] are the samples of the Fourier transform S(ω) of the transmitted UWB pulse, and assuming that in the considered frequency band the above division is not ill-conditioned, the samples Yₛ[n] can be expressed as a sum of complex exponentials per Equation (3),

$${Y}_{s} [ n ] = {\sum }_{l = 1}^{L} {a}_{l} {ⅇ}^{- j ( {ω}_{L} + n {ω}_{0} ) {t}_{l}} + 𝒩 [ n ] = {\sum }_{l = 1}^{L} \tilde{{a}_{i}} {ⅇ}^{- j n {ω}_{0} {t}_{l}} + 𝒩 [ n ] \qquad ( 6 )$$

where a_{l, est}=aₗ exp(−j ω_{L} tₗ). Here and in the following, the tilde symbol ˜ and the indicator est are used interchangeably for flagging estimated values.

For an approximate determination of Y[n] and S[n] the discrete Fourier transform (DFT) method can be used. Equation (6) is asymptotically accurate, assuming that the sampling period is properly chosen to avoid aliasing. When y(t) is a periodic signal, the DFT coefficients will satisfy Equation (6) exactly.

The annihilating filter approach utilizes the fact that in the absence of noise, each exponential exp(−j n ω₀ tₗ), n in Z, can be annihilated or “nulled out” by a first-order finite-impulse-response (FIR) filter Hₗ(z)=1−exp(−j ω₀ tₗ) z⁻¹, i.e. exp(−j n ω₀ tₗ)·[1, −exp(−j ω₀ tₗ)]=0.

For an L-th order FIR filter H(z)=sum {m from 0 to L} H[m] z ^{-m}, having L zeros at zₗ=exp(−j ω₀ tₗ),

$$H ( z ) = {\sum }_{l = 1}^{L} ( 1 - {ⅇ}^{- {jω}_{0} {t}_{l}} {z}^{- 1} ) \qquad ( 7 )$$

H(z) is the convolution of L elementary filters with coefficients [1, −exp(−j ω₀ tₗ)], l from 1 to L. Since Yₛ[n] is the sum of complex exponentials, each will be annihilated by one of the roots of H(z), so that

$$( H * {Y}_{s} ) [ n ] = {\sum }_{k = 0}^{L} H [ k ] {Y}_{s} [ n - k ] = 0 , for n = L , … , N - 1. \qquad ( 8 )$$

Therefore, the information about the time delays tₗ can be obtained from the roots of the filter H(z). The corresponding coefficients a_{l, est} then can be estimated by solving the system of linear equations of Equation (6). There results an annihilating-filter technique which can be described by steps as follows:

1. Determine the coefficients H[k] of the annihilating filter

$$H ( z ) = {\sum }_{l = 1}^{L} ( 1 - {ⅇ}^{- {jω}_{0} {t}_{l}} {z}^{- 1} ) = {\sum }_{k = 0}^{L} H [ k ] {z}^{- k} \qquad ( 9 )$$

satisfying Equation (8), i.e. (H*Yₛ)[n]=0 for n =L to N−1.

2. Determine the values of tₗ by finding the roots of H(z).

3. Determine the coefficients a_{l, est} by solving the system of linear equations of Equation (6). This is a Vandermonde system, having a unique solution because the tₗ's are distinct.

4. Determine the propagation coefficients aₗ=a_{l, est} exp(j ω_{L} tₗ).

Step 1 above can be interpreted in terms of projecting the signal y(t) onto a low-dimensional subspace corresponding to its bandpass version. This projection is a unique representation of the signal as long as the dimension of the subspace is greater than or equal to the number of degrees of freedom. Specifically, since y(t) has 2 L degrees of freedom, {tₗ, 1 from 0 to L−1} and {aₗ, 1 from 0 to L−1}, it suffices to use just 2 L adjacent coefficients Yₛ[n]. This is apparent upon setting H[0]=1, whereupon the system of equations of Equation (8) becomes a high-order Yule-Walker system. While in the noiseless case the critically sampled-scheme leads to perfect estimates of all the parameters, in the presence of noise such an approach can suffer from poor numerical performance. In particular, any least-square procedure that determines the filter coefficients directly from the Yule-Walker system is likely to have poor numerical precision. In practice, numerical concerns can be alleviated by oversampling and using known techniques from noisy spectral estimation, such as the singular value decomposition (SVD).

While the resulting modification considerably improves numerical accuracy on the estimates of filter coefficients, it is recommended further to reduce sensitivity of the frequency estimates to noise. Typically, a high-order polynomial can be used, but which imposes a significant computational burden in finding the roots of the polynomial, for determining a small number of signal poles.

C. Subspace-Based Implementation

For superior robustness in the presence of noise, an alternative technique can be used, based on state space modeling. It avoids root finding, in favor of matrix manipulations. Robust parameter estimates are obtained, not by over-modeling, but by suitably taking advantage of the structure of the signal subspace.

Previous methods for channel estimation in wideband systems typically involve solving for the desired parameters from a sample estimate of the covariance matrix, resorting to the Nyquist sampling rate, or even fractional sampling. When applied to UWB systems, such techniques would require sampling rates on the order of GHz and computational power not affordable in most UWB applications. The technique described below is aimed at estimating the parameters from a low-dimensional signal subspace, without requiring explicit computation of the covariance matrix.

From a set of coefficients Yₛ[n]=sum {1 from 1 to L} a_{l, est} zₗⁿ+N[n], the data matrix

$${Y}_{s} = ( \begin{matrix}{Y}_{s} [ 0 ] & {Y}_{s} [ 1 ] & ⋯ & {Y}_{s} [ Q - 1 ] \\ {Y}_{s} [ 1 ] & {Y}_{s} [ 2 ] & ⋯ & {Y}_{s} [ Q ] \\ ⋮ & & & \\ {Y}_{s} [ P - 1 ] & {Y}_{s} [ P ] & ⋯ & {Y}_{s} [ P + Q - 2 ]\end{matrix} ) \qquad ( 10 )$$

can be formed. In the absence of noise, he matrix Yₛ can be decomposed as Yₛ=UΛV_{T}, where

$$\begin{matrix}U = ( \begin{matrix}1 & 1 & 1 & ⋯ & 1 \\ {z}_{1} & {z}_{2} & {z}_{3} & ⋯ & {z}_{L} \\ ⋮ & & & & \\ {z}_{1}^{P - 1} & {z}_{2}^{P - 1} & {z}_{3}^{P - 1} & ⋯ & {z}_{L}^{P - 1}\end{matrix} ) & ( 11 ) \\ Λ = diag ( \begin{matrix}\tilde{{a}_{1}} & \tilde{{a}_{2}} & \tilde{{a}_{3}} & ⋯ & {\tilde{a}}_{L}\end{matrix} ) & ( 12 ) \\ V = ( \begin{matrix}1 & 1 & 1 & ⋯ & 1 \\ {z}_{1} & {z}_{2} & {z}_{3} & ⋯ & {z}_{L} \\ ⋮ & & & & \\ {z}_{1}^{Q - 1} & {z}_{2}^{Q - 1} & {z}_{3}^{Q - 1} & ⋯ & {z}_{L}^{Q - 1}\end{matrix} ) & ( 13 )\end{matrix}$$

U and V are Vandermonde matrices, with shift-invariant subspace property represented by
\overline{U}=U·Φ and \overline{V}=V·Φ (14)
where Φ is a diagonal matrix having zₗ's along the main diagonal. In the absence of noise, Yₛ has rank L. Aresulting technique can be described as follows:

1. From the set of the spectral coefficients Yₛ[n], form a P by Q matrix Yₛ, wher P,Q≧L.

2. Determine the singular value decomposition of Yₛ,
Yₛ=UₛΛₛVₛ^{H}+UₙΛₙVₙ^{H} (15)
where the columns of Uₛ and Vₛ are L principal left and right singular vectors of Yₛ, respectively.

3. Estimate the signal poles z=exp(−j ω₀ tₗ) by computing the eigenvalues of a matrix defined as
Z=Uₛ+·\overline{Uₛ} (16)

Alternatively, if Vₛ is used in Equation (17) instead of Uₛ, one would estimate complex conjugates of zₗ's because, in the definition of the SVD, Vₛ is used with the Hermitian transpose

4. Determine the coefficients a_{l, est} from the Vandermonde system of Equation (6) by fitting the L exponentials exp(−j n ω₀ tₗ) to the data set Yₛ[n].

As described, nonlinear estimation has been converted into a simpler task of estimating the parameters of a linear model. Nonlinearity is postponed for the step where the information about the time delays is obtained from the estimated signal poles. Estimation of the covariance matrix is avoided, which typically would have required a larger data set and represented a computationally demanding part in other methods. Desired estimation performance is realized with reduced sampling rates and lower computational requirements. In case the filter is not an ideal bandpass filter, in the considered frequency band the computed coefficients Y[n]ₑₛₜ have to be divided by the corresponding DFT coefficients of the filter, provided that this division is well-conditioned.

D. Estimating More General Channel Models

A channel may take into account certain bandwidth-dependent properties because, as a result of the very large bandwidth of UWB signals, components propagating along different propagation paths can undergo different frequency-selective distortion. Correspondingly, a suitable model for UWB systems is of the form

$$h ( t ) = {\sum }_{l = 1}^{L} {a}_{l} {p}_{l} ( t - {t}_{l} ) \qquad ( 17 )$$

where pₗ(t) are different pulse shapes corresponding to different propagation paths. In this case, the DFT coefficients computed from a bandpass version of the received signal can be represented by

$$Y [ n ] = S [ n ] {\sum }_{l = 1}^{L} {P}_{l} [ n ] {\tilde{a}}_{l} {ⅇ}^{- j n {ω}_{0} {t}_{l}} + 𝒩 [ n ] \qquad ( 18 )$$

In order to completely characterize the channel, estimates are desired for the aₗ's and tₗ's, as well as for the coefficients Pₗ[n], which typically requires a non-linear estimation procedure. Alternatively, one way to obtain a closed form solution is by approximating the coefficients Pₗ[n] up to a selected frequency with polynomials of degree D≦R−1, i.e.

$${P}_{l} [ n ] = {\sum }_{r = 0}^{R - 1} {p}_{l , r} {n}^{r} \qquad ( 19 )$$

Equation (19) now becomes

$$Y [ n ] = S [ n ] {\sum }_{l = 1}^{L} {\tilde{a}}_{l} {\sum }_{r = 0}^{R - 1} {p}_{l , r} {n}^{r} {ⅇ}^{- j n {ω}_{0} {t}_{l}} + 𝒩 [ n ] \qquad ( 20 )$$

and, with the notation c_{l,r}=a_{l, est} p_{l,r} and Yₛ[n]=Y[n]/S[n],

$${Y}_{s} [ n ] = {\sum }_{l = 1}^{L} {\sum }_{r = 0}^{R - 1} {c}_{l , r} {n}^{r} {ⅇ}^{- j n {ω}_{0} {t}_{l}} + 𝒩 [ n ] \qquad ( 21 )$$

In the following it is shown how to adapt the above-described annihilating

filter method suitably.

For a filter with multiple roots at zₗ=exp(−j ω₀ tₗ), i.e.

$$\begin{matrix}H ( z ) = {\prod }_{l = 1}^{L} {( 1 - {ⅇ}^{- j {ω}_{0} {t}_{l}} {z}^{- 1} )}^{R} \\ = {\sum }_{k = 0}^{RL} H [ k ] {z}^{- k}\end{matrix} \qquad ( 22 )$$

each component Y_{l,r}[n]=c_{l,r} n^{r} exp(−j n ω₀ tₗ) is annihilated by a filter having r+1 zeros at zₗ=exp(−j ω₀ tₗ), i.e.
H_{l,r}(z)=(1−e^{-jω}^{ₒ}^{t}^{ₗ}z⁻¹)^{r+1} (23)

Since the filter H_{l,R-1}(z) annihilates all the components Y_{l,r}[n], r from 0 to R−1, the annihilating filter for the signal Yₛ[n] can be expressed as

$$\begin{matrix}H ( z ) = {\prod }_{l = 1}^{L} {H}_{l , R - 1} ( z ) \\ = {\prod }_{l = 1}^{L} {( 1 - {ⅇ}^{- j {ω}_{0} {t}_{l}} {z}^{- 1} )}^{R}\end{matrix} \qquad ( 24 )$$

Therefore, the information about the time delays tₗ can be obtained from the roots of the filter H(z). The corresponding pulse shapes are then estimated by solving for the coefficients c_{l,r} in Equation (22). The technique can be described as follows:

1. Determine the coefficients H[k] of the annihilating filter

$$\begin{matrix}H ( z ) = {\prod }_{l = 1}^{L} {( 1 - {ⅇ}^{- j {ω}_{0} {t}_{l}} {z}^{- 1} )}^{R} \\ = {\sum }_{k = 0}^{RL} H [ k ] {z}^{- k}\end{matrix} \qquad ( 25 )$$

from the Yule-Walker system

$$H [ n ] * {Y}_{s} [ n ] = {\sum }_{k = 0}^{RL} H [ k ] {Y}_{s} [ n - k ] = 0 , \\ for n = RL , ... , N - 1. \qquad ( 26 )$$

having at least RL equations.

2. Determine the values of tₗ by finding the roots of H(z), taking into account that H(z) which satisfies Equation (27) has multiple roots at zₗ=exp(−j ω₀ tₗ),

$$H ( z ) = {\prod }_{l = 1}^{L} {( 1 - {ⅇ}^{- j {ω}_{0} {t}_{l}} {z}^{- 1} )}^{R} \qquad ( 27 )$$

This applies to noiseless case; in the presence of noise it is desirable to estimate the time delays from L roots of H(z) which are closest to the unit circle.

3. Determine the coefficients c_{l,r} by solving the system of linear equations in Equation (21).

The signal poles can also be estimated using a state-space approach, by forming the data matrix Yₛ of Equation (10) of minimum size RL by RL, and following the procedure described in Section C above. In this case, the eigenvalues of the matrix Z of Equation (16) will coincide with the signal poles zₗ=exp(−j ω₀ tₗ), yet each of the eigenvalues will have algebraic multiplicity R. Specifically, the roots of the annihilating filter H(z) of Equation (24) agree with the non-zero eigenvalues of the matrix Z.

In order to make the method more robust to noise, the system of equations in Equation (27) should be solved using the SVD, where the filter coefficients are determined as H[k]=−VₛΛₛ⁻¹Uₛ^{H}·yₛ. The same approach can be taken to solve for the weighting coefficients c_{l,r} from Equation (22). Care is required in reconstructing the pulse shapes from the set of estimated coefficient c_{l,r} where using the polynomial approximation of Equation (22) can lead to ripples in the reconstructed signal due to the Gibbs phenomenon. Similarly, reconstructing the signal from a larger set of DFT coefficients, obtained by spectral extrapolation from Equation (22) tends to be numerically unstable. A conventional approach lies in using a less abrupt truncation of the DFT coefficients by suitable windowing. Or, extrapolated DFT coefficients can be weighted with an exponentially decaying function. This can improve the accuracy of reconstruction significantly.

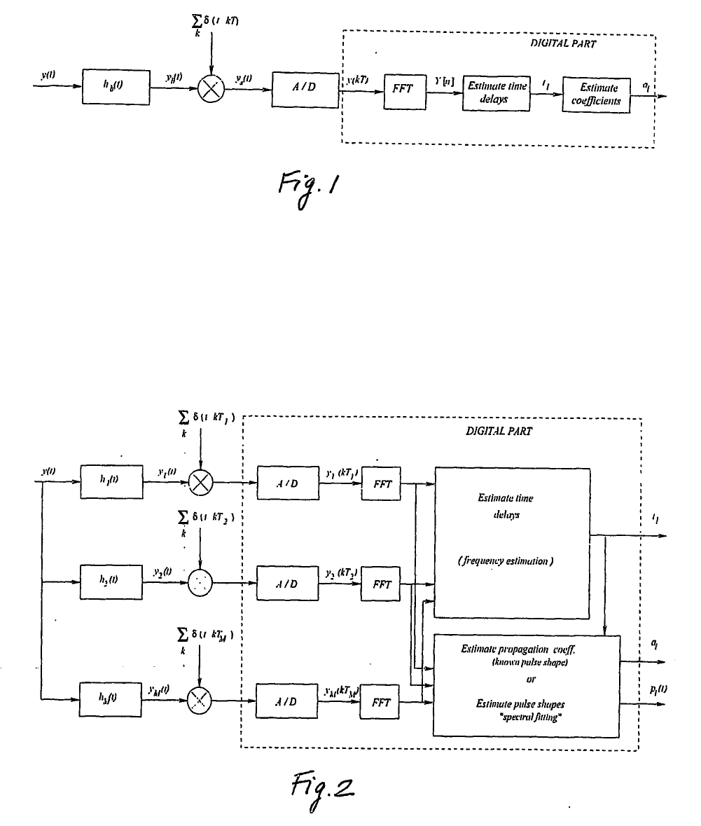

FIG. 2 illustrates a further extension, including sampling of several frequency bands and estimating the channel from a larger subspace.

E. Alternative Techniques

E-1. Estimation of Closely Spaced Components

The performance of parametric methods typically degrades if there are closely spaced sinusoidal frequencies, in the present case corresponding to the task of estimating the parameters of closely spaced paths. Provided there is sufficient separation between paths, degradation can be minimized by assuming a low-rank channel model and estimating the parameters of only dominant components. A further modification of our subspace-based method can significantly improve resolution characteristics, as described in the following.

Considering the data matrix Yₛ of Equation (10), for estimating the signal poles zₗ, the shift-invariant subspace property of Equation (14) was used, i.e. overline(U)=underline(U)·Φ, or, alternatively, overline(V)=underline(V)·Φ, where Φ is a diagonal matrix with zₗ's along the main diagonal. The Vandermonde structure of U and V allows for a more general version of Equation (14), namely,
\overline{U}^{d}=U_{d}·Φ^{d} and \overline{V}^{d}=V_{d}·Φ^{d} (28)
where markings overline_{d} and underline_{d} denote the operations of omitting the first d rows and last d rows of the marked matrix, respectively. In this case, the matrix Φ^{d} has elements zₗ^{d}=exp(−j ω₀ d tₗ) on its main diagonal, as the effective separation among the estimated time delays is increased d times. This can improve the resolution performance of the method significantly, in particular for low values of SNR.

The estimates of the time locations tₗ obtained from the powers of the signal poles zₗ^{d} are not unique. Rather, for each computed eigenvalue zₗ^{d} there exists a set of d possible corresponding time delays t_{l,est}=tₗ=n·2π/(ω₀d), n=0, . . . , d−1. In order to avoid this ambiguity, an approximate location of the cluster of paths can be determined by estimating just one principal component first, using the method of Section C above. The determination is facilitated in that the largest signal-space singular vector is relatively insensitive to signal separation. The estimated principal component can then be used in selecting a proper set of the locations tₗ, once the values of zₗ^{d} have been estimated.

E-2. Computational Economy

A major computational requirement in our techniques is associated with the singular value decomposition step, which is an iterative algorithm with computational order of O(N³) per iteration. Often, when interest is in estimating the parameters of just a a few strongest paths, computing the fall SVD of the data matrix Yₛ is not necessary. Examples include initial synchronization, and ranging or positioning. In such cases, methods can be used to find principal singular vectors, with fast convergence and reduced computational requirements. For determining the one dominant right or left singular vector of Yₛ, one such method, the power method can be described for present purposes as follows:

The P by P matrix F=YₛYₛ^{H} can be considered as diagonalizable by a matrix Λ=[yₗ, . . . , y_{P}], i.e. Λ⁻¹F Λ=diag(λₗ, . . . , λ_{P}). The λ's are real, non-negative numbers and can be assumed to be arranged in decreasing order of magnitude. Starting with a vector y⁽⁰⁾, the power method generates a sequence of vectors y^{(k)} in the following way: z^{(k)}=F y^{(k-1)}; y^{(k)}=z^{(k)}/∥z^{(k)}∥₂.

If y⁽⁰⁾ has a component in the direction of the principal left singular vector yₗ of Yₛ, and if λₗ is distinct, i.e. λₗ>λ₂, the sequence of y^{(k)}'s converges to yₗ. Once the vector yₗ has been estimated, the signal pole zₗ corresponding to the strongest signal component can be determined as zₗ=underline(yₗ)⁺ overline(yₗ). Rate of convergence of the method depends on the ratio λ₂/λ₁, and can be slow when λ₂ is close to λₗ. Algorithmic modifications for such cases are described in the book by J. W. Demmel, “Applied Numerical LinearAlgebra”, SIAM, Philadelphia, 1997, for example, which further can be referred to for a generalization of the power method. Known as orthogonal iteration, it can be used for determining higher-dimensional invariant subspaces, i.e. for finding M_{d}>1 dominant singular vectors.

The power method mainly involves simple matrix multiplications, with a computational order O(P²) per iteration. For orthogonal iteration the corresponding order is O(P²M_{d}).

F. Low-Complexity Rapid Acquisition in UWB Localizers

One application of our technique lies with UWB transceivers for low-rate, low-power indoor wireless systems, used for precise position location, for example. Such transceivers use low duty-cycle periodic transmission of a coded sequence of impulses to ensure low-power operation and good performance in a multi-path environment. Yet, rapid timing synchronization still presents a challenge in transceiver design, which can be addressed by our technique as follows:

The received noiseless signal y(t) is modeled as a convolution of L delayed, possibly different, impulses with a known coding sequence g(t), i.e.

$$y ( t ) = {\sum }_{l = 1}^{L} {a}_{l} {p}_{l} ( t - {t}_{l} ) * g ( t ) \qquad ( 29 )$$

As y(t) is a periodic signal, its spectral coefficients are exactly given by

$$Y [ n ] = {\sum }_{l = 1}^{L} {a}_{l} {P}_{l} [ n ] G [ n ] {ⅇ}^{- j n {ω}_{n} {t}_{l}} \qquad ( 30 )$$

where ω_{c}=2π/T_{c}, with T_{c} denoting a cycle time. With the polynomial approximation of the spectral coefficients Pₗ[n] from Equation (19), the total number of degrees of freedom per cycle is 2 RL. Therefore, the signal parameters can be estimated by sampling the signal uniformly at a sub-Nyquist rate, using the method presented in Section D above. Knowledge of the transmitted or received pulse shape is not required here.

In ranging/positioning applications, our technique has a further advantage in that it allows for a “multi-resolution” approach. A first, rough estimate of the sequence timing can be obtained by taking uniform samples at a low rate over an entire cycle. Then, precise delay estimation can be effected by increasing the sampling rate, yet sampling the received signal only within a narrow time window where the signal is present. Using a two-step approach can be motivated in that a sequence of duration Tₛ typically spans a small fraction of the cycle time T_{c}, e.g. less than 20%. As a result, previous search-based methods require a very long acquisition time and appear to “waste” power in sampling and processing time slots where the signal is absent.

The following scenario can serve for estimating the reduction of computational and power requirements from the two-step approach. A signal is first sampled at a low rate Nₗ over the entire cycle, and the power method is used for coarse synchronization. The signal next is sampled at a higher rate Nₕ still below the Nyquist rate Nₙ over a narrow time window of duration of approximately Tₛ, and M_{d} dominant signal components are estimated using the method of orthogonal iteration. In the low SNR regime, SNR<0 dB, a typical range for Nₗ is between Nₙ/40 and Nₙ/20, while Nₕ takes on values between Nₙ/10 and Nₙ/2. Benefits of the two-step approach have been ascertained as follows:

As to reduction of computational and power requirements with increasing values of T_{c}/Tₛ, when Nₗ=Nₙ/40, Nₕ=Nₙ/4, M_{d}=1 and T_{c}/Tₛ=10, the two-step approach reduces complexity of the original subspace method by a factor of about 50, and power consumption is reduced by a factor of 5. Similarly, as Nₕ decreases, the advantages of the subspace method over the matched filter approach become more pronounced. Due to the search-based nature of the matched filter method, it requires a much longer acquisition time as compared to our subspace and two-step techniques, where it suffices to sample at most two signal cycles. In practice, in the low SNR regime, it is desirable to average the samples from multiple cycles in order to increase the effective SNR and thus to improve the numerical performance. While this does not have a major effect on the computational requirements, power consumption increases linearly with the number of averaging cycles. Thus, a good choice of the number of cycles depends on power constraints, a desirable estimation precision and acquisition time. For the two-step technique, the overall performance improves upon averaging the samples during the second phase only, in fine synchronization. During the first phase, it is useful to average the samples only if the processing gain is not sufficiently high to allow for coarse acquisition from a subsampled signal, without affecting over-all performance.

G. Simulation Results

The results described here are based on averages over 500 trials, each with a different realization of additive white Gaussian noise. A UWB system is considered where a sequence of UWB impulses is periodically transmitted, coded with a pseudo-noise (PN) sequence of length 127. The n-th transmitted pulse is multiplied by +1 or −1, according to the n-th chip in the PN sequence. For the discrete time signals, time will be expressed in terms of samples, where one sample corresponds to the period of Nyquist-rate sampling. The relative time delay between the transmitted pulses, i.e. the chips in the sequence, is taken as 20 samples. The sequence duration Tₛ spans approximately 20% of the cycle time T_{c}.

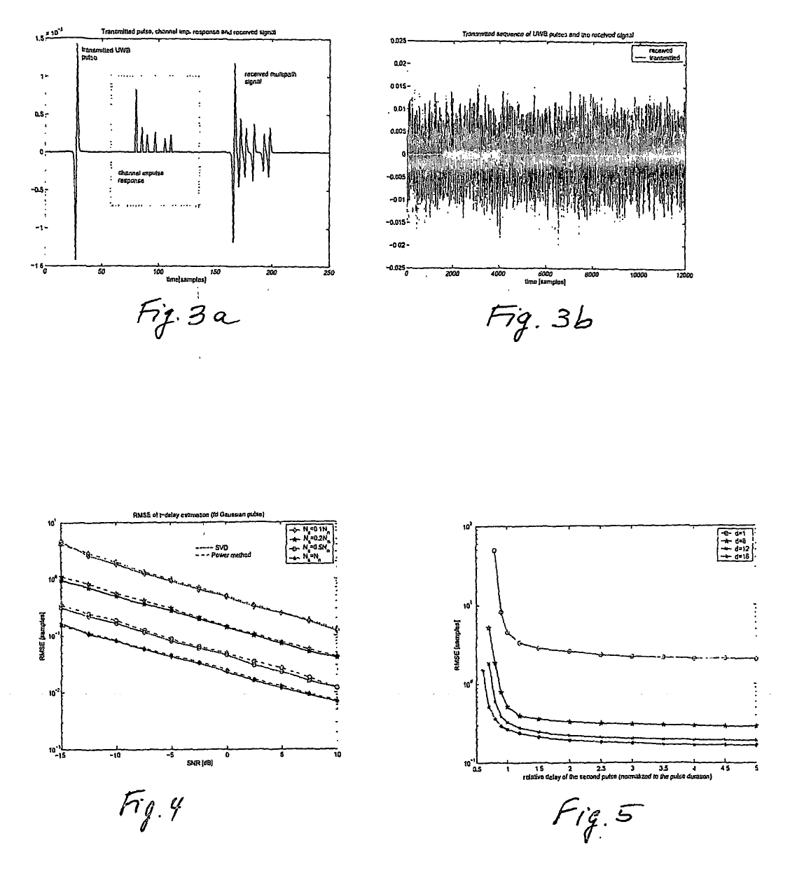

For the channel model of FIG. 1, with six propagation paths including one dominant path containing 70% of total power, FIG. 3a shows the transmitted UWB pulse as an ideal first-derivative Gaussian impulse with a duration Tₚ of about 5 samples. FIG. 3b shows the received noiseless sequence in grey within a cycle of a received noisy signal in black. The received signal-to-noise ratio is SNR=−15 dB.

For the subspace technique of Section C above, FIG. 4 shows root-mean square errors (RMSE) of time delay estimation for the dominant component. The results show that the method yields highly accurate estimates, i.e. with a sub-chip precision for a wide range of SNR's, and this with sub-Nyquist sampling rates. For example, with the sampling rate of one fifth the Nyquist rate, Nₛ=Nₙ/5 and SNR=−10 dB, the time delay along the dominant path can be estimated with an RMSE of approximately 0.5 samples. The timing performance of the SVD-based algorithm is compared with the results obtained using a simpler approach based on the power method. The two methods yield essentially the same RMSE, and the performance of both methods improves as the sampling rate increases.

For the channel model of FIG. 1, but now with two dominant components each containing 40% of the total power, RMSE of time delay estimation over the dominant paths versus the relative delay between the two components is shown in FIG. 5 when SNR=−5 dB and the sampling rate is Nₛ=Nₙ/5. The results were obtained with the original SVD-based algorithm and its modified version of Section E above. The results are shown for different values of the parameter d which determines the effective separation between the estimated time delays. The modified method yields resolution performance better by an order of magnitude. As the time delay of the second component relative to the first decreases below the pulse duration, the performance of the original method degrades rapidly, while the modified method offers a remedy by increasing the value of d. For example, when d=12, the two components can be resolved even when the relative peak-to-peak time delay between the pulses is a fraction of the pulse duration Tₚ.

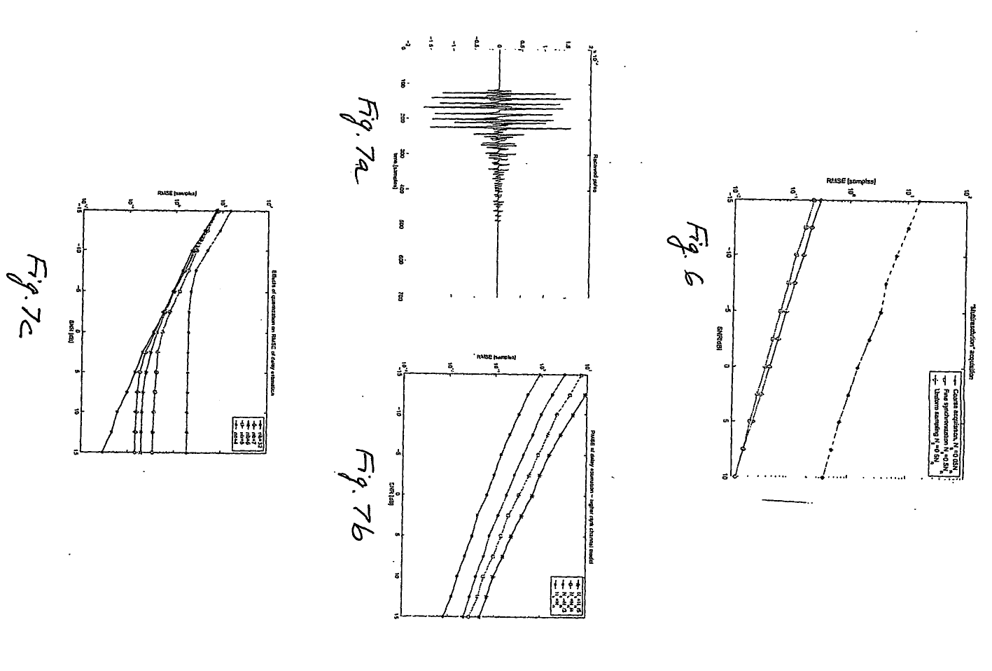

FIG. 6 illustrates performance of multi-resolution or two-step delay estimation. The first step is coarse synchronization, when the signal is sampled uniformly over the entire cycle at a low rate Nₗ to obtain a rough estimate of the sequence timing. The second step is fine synchronization, where the signal is sampled only within a narrow time window, but at a higher rate Nₕ. RMSE is shown for Nₗ=0.05Nₙ and Nₕ=0.5Nₙ. As the subsampling factor during the first phase is 20, for low values of SNR, i.e. less than −5 dB, the samples are averaged over multiple cycles in order to increase the effective SNR. The error is compared to the RMSE obtained when the signal is sampled uniformly at a rate Nₕ=0.5Nₙ over the entire cycle. The results show that the two methods yield similar performance, with the two-step approach reducing the computational requirements by a factor of 20 and the power consumption by a factor of 3.3.

FIGS. 7a, 7b and 7c are for the channel model of FIG. 1, with L=70 propagation paths including eight dominant paths containing 85% of total power. The average peak-to-peak time delay between the received dominant components is taken as 2Tₚ.

FIG. 7b shows RMSE of delay estimation for the dominant components versus SNR of Section E above, with the parameter choice d=30. The method yields highly accurate estimates, for a wide range of SNR'S. For example, when Nₛ=Nₙ/4 and SNR=−5 dB, the delay of the dominant components can be estimated with an RMSE of approximately 1 sample.

FIG. 7c shows the effects of quantization on estimation performance for 4 to 7 bit architectures. RMSE is plotted versus received SNR. The results are compared also to the “ideal” case of n_{b}=32 bits used for quantization. As the number of bits increases, the overall performance improves, with the 5-bit architecture yielding a very good performance already. When n_{b}≧5 and the value of SNR is low, e.g. SNR<0 dB, quantization has almost no impact on the estimation performance. As the value of SNR increases, quantization noise becomes dominant and determines the overall numerical performance.

1. A computerized method for estimating impulse response of a wideband communication channel represented as a linear combination of L time-shifted pulses pₗ(t) with propagation coefficients aₗ, comprising:
(a) obtaining an ultra-wideband signal received over the channel, filtered with a lowpass/bandpass filter and sampled uniformly at a sub-Nyquist rate;
(b) determining discrete-Fourier-transform coefficients yⱼ and sⱼ from the sampled received signal and a transmitted ultra-wide-band pulse, respectively;
(c) determining dominant singular vectors of a matrix having yⱼ₊ᵢ₋₁/sⱼ₊ᵢ₋₁ as its i,j-elements;
(d) estimating a plurality of signal poles from the dominant singular vectors and determining the time shifts from the estimated signal poles; and
(e) determining the propagation coefficients from a system of linear equations.

2. A computerized method for estimating impulse response of a wideband communication channel represented as a linear combination of L time-shifted pulses pₗ(t) with propagation coefficients aₗ, comprising:
(a) obtaining an ultra-wideband signal received over the channel, filtered with a lowpass/bandpass filter and sampled uniformly at a sub-Nyquist rate;
(b) determining discrete-Fourier-transform coefficients yⱼ and sⱼ from the sampled received signal and a transmitted ultra-wide-band pulse, respectively;
(c) determining dominant singular vectors of a matrix having yⱼ₊ᵢ₋₁/sⱼ₊ᵢ₋₁ as its i,j-elements;
(d) estimating a plurality of powers of the signal poles from the dominant singular vectors and determining the time shifts from the estimated powers; and
(e) determining the propagation coefficients from a system of linear equations.

3. The method of claim 2, wherein the communication channel comprises close-spaced paths.

4. The method of claim 1 or 2, wherein the pulses pₗ(t) comprise delta pulses.

5. The method of claim 1 or 2, wherein the pulses pₗ(t) are substantially the same.

6. The method of claim 1 or 2, wherein the estimated discrete-Fourier-transform coefficients of each of the pulses pₗ(t) are approximated by a polynomial whose degree does not exceed an integer R.

7. The method of claim 1 or 2, wherein L is chosen as the number of dominant singular vectors in step (c).

8. The method of claim 1 or 2, wherein the representation is of reduced rank and L is chosen as less than the number of dominant singular vectors in step (c).

9. The method of claim 1 or 2 effected repeatedly, first with the signal sampled at a first sub-Nyquist rate over a first time interval yielding a first estimate of sequence timing, followed by the signal sampled over a second time interval shorter than the first time interval and at a second sub-Nyquist rate greater than the first rate, yielding a second, improved estimate.

10. A system for estimating impulse response of a wideband communication channel represented as a linear combination of L time-shifted pulses pₗ(t) with propagation coefficients aₗ, comprising:
(a) a functionality for obtaining an ultra-wideband signal received over the channel, filtered with a lowpass/bandpass filter and sampled uniformly at a sub-Nyquist rate,
(b) a functionality for determining discrete-Fourier-transform coefficients yⱼ and sⱼ from the sampled received signal and a transmitted ultra-wide-band pulse, respectively;
(c) a functionality for determining dominant singular vectors of a matrix having yⱼ₊ᵢ₋₁/sⱼ₊ᵢ₋₁ as its i,j-elements;
(d) a functionality for estimating at least a first power of signal poles from the dominant singular vectors and determining the time shifts from the estimated at-least-first-power of the signal poles; and
(e) a functionality for determining the propagation coefficients from a system of linear equations.

11. A system for estimating impulse response of a wideband communication channel represented as a linear combination of L time-shifted pulses pₗ(t) with propagation coefficients aₗ, comprising:
(a) a functionality for obtaining an ultra-wideband signal received over the channel, filtered with a lowpass/bandpass filter and sampled uniformly at a sub-Nyquist rate;
(b) a functionality for determining discrete-Fourier-transform coefficients yⱼ and sⱼ from the sampled received signal and a transmitted ultra-wide-band pulse, respectively;
(c) a functionality for determining dominant singular vectors of a matrix having yⱼ₊ᵢ₋₁/sⱼ₊ᵢ₋₁ as its i,j-elements;
(d) a functionality for estimating a plurality of powers of the signal poles from the dominant singular vectors and determining the time shifts from the estimated powers; and
(e) a functionality for determining the propagation coefficients from a system of linear equations.

12. The system of claim 11, wherein the communication channel comprises close-spaced paths.

13. The system of claim 10 or 11, wherein the pulses pₗ(t) comprise delta pulses.

14. The system of claim 10 or 11, wherein the pulses pₗ(t) are substantially the same.

15. The system of claim 10 or 11, wherein the estimated discrete-Fourier-transform coefficients of each of the pulses pₗ(t) are approximated by a polynomial whose degree does not exceed an integer R.

16. The system of claim 10 or 11, further comprising a functionality for choosing L as the number of dominant singular vectors determined by functionality (c).

17. The system of claim 10 or 11, wherein the representation is of reduced rank, and the system comprises a functionality for choosing L as less than the number of dominant singular vectors determined by functionality (c).

18. The system of claim 10 or 11 comprising a functionality for repetition, first with the signal sampled at a first sub-Nyquist rate over a first time interval yielding a first estimate of sequence timing, followed by the signal sampled over a second time interval shorter than the first time interval and at a second sub-Nyquist rate greater than the first rate, for yielding a second, improved estimate.
